(19) United States
(12) Patent Application Publication
(10) Pub. No.: US 2007/0160333 A1
(43) Pub. Date: Jul. 12, 2007

(54) INTERCHANNEL-TIME CODING METHOD FOR MULTICHANNEL TRANSMISSION SYSTEMS

(75) Inventors: Frank Schaich, Stuttgart (DE); Joachim Speidel, Sindelfingen (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL LUCENT, Paris (FR)

(21) Appl. No.: 11/608,182

(22) Filed: Dec. 7, 2006

(30) Foreign Application Priority Data
Jan. 10, 2006 (EP) 06290065.9

(51) Int. Cl. G02B 6/44

(52) U.S. Cl. 385/100

(57) ABSTRACT

A coding method for multichannel optical transmission systems (10) is described, in which coding is carried out both in the time direction and over a plurality of channels, a mapping being selected for the coding such that the simultaneous occurrence of bits with a signal value of ‘1’ in neighbouring channels is excluded. A multichannel optical transmission system for carrying out the method is furthermore described, as well as a coder (12) for use in conjunction with such a multichannel optical transmission system (10).

The invention is based on a priority application EP 06290065.9 which is hereby incorporated by reference.

### FIELD OF THE INVENTION

The invention relates to a coding method for multichannel, in particular optical transmission systems, in which coding is carried out both in the time direction and over a plurality of channels, according to the precharacterising clause of Claim 1.

### BACKGROUND OF THE INVENTION

Interchannel-time coding, also known as wavelength-time Coding (WTC), is a coding method by which multichannel optical transmission systems with strong interchannel interference (ICI) can achieve a more robust transmission behaviour. Multichannel optical transmission networks are also known by the terms photonic networks, wavelength multiplex systems and wavelength division multiplexed optical systems (WDM).

In interchannel-time coding, coding is carried out not only in the time direction but also over a plurality of channels. The bits of the channels involved are employed for the coding.

U.S. Pat. No. 6,313,932 B1 and U.S. Pat. No. 6,522,436 B2 disclose a coding method for multichannel optical transmission systems in which an error correction method, which comprises both interchannel coding and time coding, is applied to the data transmitted in the channels. The coding is in this case carried out by means of a Hamming code scheme.

In a coding method comprising both interchannel coding and time coding, it is furthermore known from U.S. Pat. No. 6,313,932 B1 and U.S. Pat. No. 6,522,436 B2 to make the time coding more robust by interleaving.

Interleaving is primarily applied in order to safeguard the data transmission against so-called burst errors. It utilises the property of these errors that even though they destroy a sizeable number of continuous bits when they occur, they are nevertheless relatively infrequent. Additional error correction information, by which individual bit errors can be corrected, is jointly transmitted for all the data independently of the interleaving. If a burst error now occurs which alters not just one bit but a group of bits, then this set can no longer be corrected. By the interleaving, a larger set of individual bit errors is artificially generated from the burst error by drawing the data to be transmitted bitwise in length, and consequently a plurality of independent data transmitted in parallel.

A disadvantage with this method is that the transmitter must first bring the data to be transmitted into the interleaved form. For this purpose, however, all the data which are intended to be interleaved must be available. A data block cannot be transmitted until the data block has fully arrived in the transmission buffer. Correspondingly, the receiver cannot restore the data into the correct sequence until the packet has completely arrived. This leads to a delay of the order of about double the transmission time of a data packet.

U.S. Pat. No. 5,710,797 discloses a method which permits a reduced channel spacing in digital communication systems. The method allows simultaneous data transmission in mutually overlapping channels, by using a demodulator which is capable of obtaining data bits of a desired signal in the presence of other tightly spaced signals. The narrow channel spacing which is therefore possible improves the capacity and therefore the possible number of users per specific bandwidth of digital communication systems.

The continuing development in the field of telecommunications, information and data transmission nevertheless requires further improvements in order to reduce the operating costs of optical and/or electromagnetic digital transmission systems and further increase the possible transmission rates.

It is therefore an object of the invention to develop a coding method which permits lower system costs.

### SUMMARY OF THE INVENTION

For a method of the generic type mentioned in the introduction, the object is achieved in that a mapping is selected for the coding such that the simultaneous occurrence of bits with a signal value of ‘1’ in neighbouring channels coded together is excluded.

In the mapping, each possible bit pattern to be transmitted is allocated a particular coded bit pattern. This allocation is provided, for example, in the form of a table. A coder on the transmitter side maps the bit pattern to be transmitted, which comprises the transmission sequences of the channels to be coded together, at its input into a coded bit pattern which comprises the coded sequences of transmission sequences, and outputs this. The output coded bit pattern C is subsequently transmitted over a fibre link. A decoder on the receiver side reallocates the original bit pattern to the coded bit pattern.

The coding method according to the invention has the advantage over the prior art that since a ‘1’ is never simultaneously injected into the fibre in channels coded together, the maximum injection power when coding in pairs is reduced by half. This reduces the nonlinear effects of the fibre. The maximum injection power is likewise reduced when coding in triples, but not so greatly as with pairs. The coding method according to the invention improves the optical signal-to-noise ratio (OSNR) of the optical transmission system, so that the bit error rate (BER) at the receiver is reduced. By means of the interchannel-time coding method according to the invention, it is therefore possible to achieve a smaller channel spacing and therefore a high spectral efficiency for a constant BER, or the link length which can be covered is increased so that the system costs are reduced.

The following three optimisation strategies, for example, may be envisaged for the mapping in the coding method according to the invention:
a) Maximising the Hamming distance,
b) Minimising the Hamming weights, by minimising the frequency of the ‘s’ as transmission symbols in the coded transmission sequences, in order to reduce the ICI as well,
c) Minimising the number of ‘0 1’ and ‘1 0’ bit patterns in the time direction in order to keep the inner eye aperture, which is limited by ISI, as great as possible.

According to a preferred configuration of the coding method according to the invention, all possible codewords are evaluated in the decoding and the codeword With the maximal metric is selected.

According to a preferred configuration of the coding method according to the invention, the least likely codewords are excluded by means of an algorithm before the actual decoding so that not all the metrics have to be evaluated. This reduces the outlay required for the decoding.

According to another preferred configuration of the coding method according to the invention, the channels are grouped in pairs, the coding being carried out over the channels grouped in pairs.

According to another preferred configuration of the coding method according to the invention, the channels are grouped in triples, the coding being carried out over the channels grouped in triples. Grouping the channels into triples instead of pairs increases the spectral efficiency, yet the decoding can still be implemented with comparatively little outlay.

According to a particularly preferred configuration of the coding method according to the invention, the interchannel-time coding is combined with Reed-Solomon coding.

A preferred configuration of the invention relates to a multichannel optical transmission system for carrying out the coding method described above, the multichannel optical transmission system comprising means arranged on the transmitter side for the interchannel-time coding of a plurality of channels which can be transmitted by means of an optical fibre link and means arranged on the receiver side for decoding the channels transmitted via the optical fibre link, the interchannel-time coding means comprising means for carrying out a mapping such that the simultaneous occurrence of bits with a signal value of ‘1’ in neighbouring channels is excluded.

According to a preferred configuration of the multichannel optical transmission system according to the invention, a maximum likelihood symbol-by-symbol decoder is used for the decoding.

According to another preferred configuration of the multichannel optical transmission system according to the invention, a sphere decoder is used for the decoding.

A particularly preferred configuration of the multichannel optical transmission system according to the invention comprises additional means for carrying out Reed-Solomon coding.

Another preferred configuration of the invention relates to a coder which comprises means for the interchannel-time coding of transmission sequences of neighbouring channels, the means for the interchannel-time coding of neighbouring channels comprising means for carrying out a mapping such that the simultaneous occurrence of bits with a signal value of ‘1’ in neighbouring channels is excluded.

### BRIEF DESCRIPTION OF THE DRAWINGS

A preferred embodiment of the invention will be described below with reference to the accompanying drawings in which:

FIG. 1 shows a schematic representation of an optical transmission system with interchannel-time coding.

FIG. 2 shows a schematic representation of the channel patterns of multichannel transmission systems compared with one another,

FIG. 3 shows a diagram which plots the bit error rate (BER) of different multichannel transmission systems compared with one another, against the optical signal-to-noise ratio (OSNR), and

FIG. 4 shows a diagram which plots the bit error rate (BER) of different multichannel transmission systems compared with one another, against the optical signal-to-noise ratio (OSNR) while taking into account the intersymbol interference (ISI).

### DETAILED DESCRIPTION OF THE INVENTION

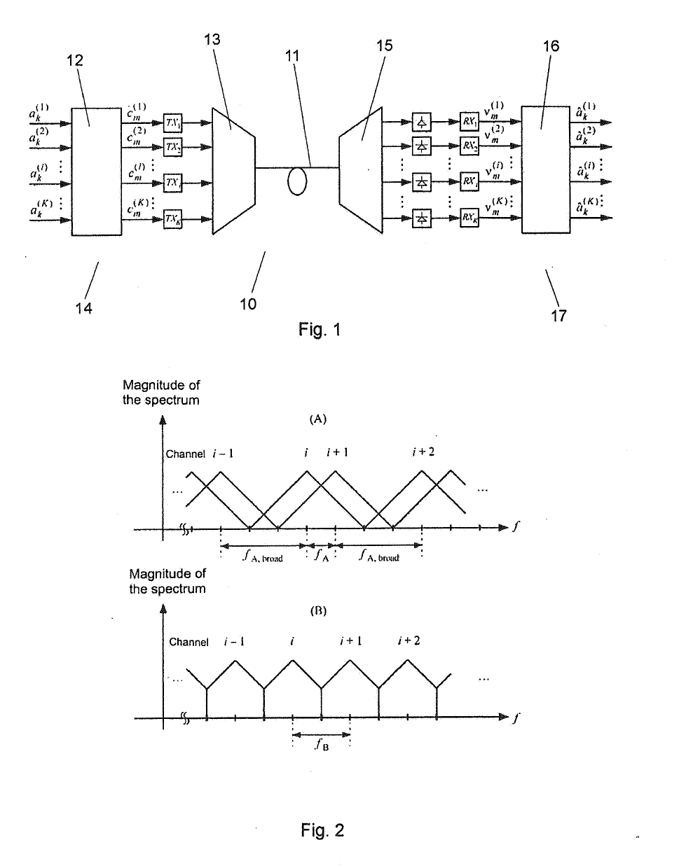

An optical transmission system 10 with interchannel-time coding as represented in FIG. 1 consists essentially of a fully compensated optical transmission link 11, an interchannel-time coder 12 and a multiplexer 13 on the transmitter side 14, and a demultiplexer 15 and an interchannel-time decoder 16 on the receiver side 17. FIG. 1 also gives a simplified representation of the transmitters TXᵢ on the transmitter side 14 and, on the receiver side 17, the receivers RXᵢ of the respective channels i. The transmitters TXᵢ comprise all the necessary components from the pulse shaper to the modulator, and the receivers RXᵢ comprise all the necessary components from the reception filter to the sampler.

In the coder, N consecutive bits of M channels interchannel-coded together form the M×N input matrix of decoder. M≦K should be selected here, where K is the total number of channels of the WDM system. The coder adds Q parity bits per channel and outputs the M×(N+Q) output matrix with the elements cₘ₋ᵥ⁽ⁱ⁾(v=0, . . . , N+Q−1; i=1, . . . M; m ε Z). Here, i indicates the channel number and m is the discrete time. In order to represent the principle, M=2 will be set below. The coder then carries out the following allocation:

$$\underbrace{( \begin{matrix}{a}_{k - N + 1}^{( 1 )} … {a}_{k}^{( 1 )} \\ {a}_{k - N + 1}^{( 2 )} … {a}_{k}^{( 2 )}\end{matrix} )}_{A} \to \underbrace{( \begin{matrix}{c}_{m - N - Q + 1}^{( 1 )} … {c}_{m}^{( 1 )} \\ {c}_{m - N - Q + 1}^{( 2 )} … {c}_{m}^{( 2 )}\end{matrix} )}_{C} \qquad ( 1 )$$

Such an allocation is referred to as mapping. In the mapping, each possible bit pattern A to be transmitted is allocated a particular coded bit pattern C. These allocations are provided, for example, in the form of a table. A coder on the transmitter side maps the bit pattern A to be transmitted, which comprises the transmission sequences a⁽ⁱ⁾_{k-N+1}, . . . a⁽ⁱ⁾ₖ of the channels to be coded together, at its input into a coded bit pattern C which comprises the coded sequences c⁽ⁱ⁾_{m-N-Q+1} . . . c⁽ⁱ⁾ₘ of transmission sequences, and outputs this. The output coded bit pattern C is subsequently transmitted over a fibre link. A decoder on the receiver side reallocates the original bit pattern A to the coded bit pattern C. In the interchannel-time coding method according to the invention, the coded bit patterns C in neighbouring channels never simultaneously contain a ‘1’ since it is unfavourable in respect of the ICI and therefore the bit error rate (BER) for a ‘1’ to arrive simultaneously in neighbouring channels.

Let the bit rate of the transmission sequence aₖ⁽ⁱ⁾ be V=1/T. A bit rate of V′=1/T′ then follows for the coded sequence cₘ⁽ⁱ⁾, in which case the following must apply: TN=T′(N+Q). A possible mapping for N=1 and Q=1 is of the following form:

$$( \begin{matrix}0 \\ 0\end{matrix} ) \to ( \begin{matrix}0 & 0 \\ 0 & 0\end{matrix} ) ; ( \begin{matrix}0 \\ 1\end{matrix} ) \to ( \begin{matrix}0 & 1 \\ 0 & 0\end{matrix} ) ; ( \begin{matrix}1 \\ 0\end{matrix} ) \to ( \begin{matrix}1 & 0 \\ 0 & 0\end{matrix} ) ; ( \begin{matrix}1 \\ 1\end{matrix} ) \to ( \begin{matrix}1 & 0 \\ 0 & 1\end{matrix} ) \qquad ( 2 )$$

In principle, there are a multiplicity of possible mappings. According to the invention, however, as represented for a simplified example in (2), no codewords occur which contain a ‘1’ in neighbouring lines, i.e. in neighbouring channels.

A maximum likelihood symbol-by-symbol decoder is used for the decoding. The decoder evaluates the following Equation (3) for all possible codewords and selects the one with the maximal metric. For the above example with M=2, it is of the following form:

$$p \text{(} {v}_{m - N - Q + 1}^{( 1 )} , … , {v}_{m}^{( 1 )} , {v}_{m - N - Q + 1}^{( 2 )} , … , {v}_{m}^{( 2 )} \vert {c}_{m - N - Q + 1}^{( 1 )} , … , {c}_{m}^{( 1 )} , {c}_{m - N - Q + 1}^{( 2 )} , … , {c}_{m}^{( 2 )} ) = {\prod }_{n = - N - Q + 1}^{0} q \text{(} {v}_{m + n}^{( 1 )} \vert {c}_{m + n}^{( 1 )} , {c}_{m + n}^{( 2 )} ) \cdot {\prod }_{n = - N - Q + 1}^{0} q \text{(} {v}_{m + n}^{( 2 )} \vert {c}_{m + n}^{( 1 )} , {c}_{m + n}^{( 2 )} ) \qquad ( 3 )$$

This assumes statistically independent noise. If intersymbol interference (ISI) also occurs within the channels, and this is to be taken into account for the decision process, then the decoder must evaluate the following Equation (4):

$$p \text{(} {v}_{m - N - Q + 1}^{( 1 )} , … , {v}_{m}^{( 1 )} , {v}_{m - N - Q + 1}^{( 2 )} , … , {v}_{m}^{( 2 )} \vert {c}_{m - N - Q}^{( 1 )} , … , {c}_{m + 1}^{( 1 )} , {c}_{m - N - Q}^{( 2 )} , … , {c}_{m + 1}^{( 2 )} ) = {\prod }_{n = - N - Q + 1}^{0} q \text{(} {v}_{m + n}^{( 1 )} \vert {c}_{m + n - 1}^{( 1 )} , {c}_{m + n}^{( 1 )} , {c}_{m + n + 1}^{( 1 )} , {c}_{m + n - 1}^{( 2 )} , {c}_{m + n}^{( 2 )} , {c}_{m + n + 1}^{( 2 )} ) \cdot {\prod }_{n = - N - Q + 1}^{0} q \text{(} {v}_{m + n}^{( 2 )} \vert {c}_{m + n - 1}^{( 1 )} , {c}_{m + n}^{( 1 )} , {c}_{m + n + 1}^{( 1 )} , {c}_{m + n - 1}^{( 2 )} , {c}_{m + n}^{( 2 )} , {c}_{m + n + 1}^{( 2 )} ) \qquad ( 4 )$$

Here, c⁽¹⁾_{m-N-Q} and c⁽²⁾_{m-N-Q} are the last bits of the preceding, c⁽ⁱ⁾ₘ₊₁ and c⁽²⁾ₘ₊₁ are the first of the subsequent codeword. In the exemplary embodiment, the ISI is limited to the realistic case of only two samples. q(.|.) is the probability density function of the noisy reception symbols v⁽¹⁾ₘ₊ₙ and v⁽²⁾ₘ₊ₙ, respectively.

Besides such a soft-in-hard-out (SIHO) decoder, a hard-in-hard-out (HIHO) decoder may also be envisaged. In this case, a threshold value decision is carried out instead of the ML detection. The Hamming distance of the received symbol from all the possible ones is used as the decoder criterion. The symbol with the minimal Hamming distance is selected. A combination of both is possible in order to combine the advantages of the two described decoders (HIHO: straightforward implementation, SIHO: more accurate decoding, more robust). In this case, the least likely codewords are excluded by means of an algorithm before the actual decoding, so that not all the metrics have to be evaluated.

In the coding method according to the invention, the bit error rate is substantially reduced because no codewords occur which contain a ‘1’ in neighbouring lines, i.e. in neighbouring channels. This criterion can is satisfied, for example, by the mapping represented in (2). For this mapping, N=1 and Q=1. The codeword space consists of N_{C}=3^{(N+Q)} elements in this case, whereas the transmission symbol space comprises N_{A}=4^{N} symbols. So long as the condition N_{C}≧N_{A} is satisfied as in the exemplary embodiment, then N_{C}−N_{A} degrees of freedom are available for the further code design. For example, the following three different optimisation strategies may be envisaged:
a) Maximising the Hamming distance,
b) Minimising the Hamming weights, by minimising the frequency of the ‘1s’ as transmission symbols in the coded transmission sequences, in order to reduce the ICI as well,
c) Minimising the number of ‘0 1’ and ‘1 0’ bit patterns in the time direction in order to keep the inner eye aperture, which is limited by ISI, as great as possible.

Two multichannel optical transmission systems with interchannel-time coding according to the invention and three multichannel optical transmission systems with different conventional coding methods will be compared below.

In the transmission systems with interchannel-time coding according to the invention, N=3 and Q=1 are selected. N=3 and Q=1 represent a good compromise between performance, complexity and bit rate increase. The probability density functions q(.|.) (cf. Equations (3) and (4)) of the metrics are chi² distributions for the exemplary embodiment with N=3 and Q=1. Other probability density functions, for example a Gaussian distribution, could also be envisaged. The code rate R=3/4 and an overhead of 33% are obtained for N=3 and Q=1. Since the complexities of the coder and the decoder grow with an increasing number M of the channels to be interchannel coded together, M=2 is furthermore selected in the transmission systems with interchannel-time coding according to the invention, that is to say the channels are provided pairwise with interchannel-time coding. M=2 is expedient in conjunction with multichannel optical transmission systems having a total channel number K>2. A solution with triples instead of pairs, i.e. coding three channels together instead of two, increases the spectral efficiency while the decoding still remains viable.

For the transmission systems with interchannel-time coding, it is preferable to use a channel raster such as that represented in FIG. 2(A). Two different channel spacings occur in the channel raster represented in FIG. 2(A). f_{A} is the spacing between the two channels coded together, and f_{A,broad} is the spacing between the channels which are not coded together. Since the channels coded together are optimised in respect of the ICI by the mapping according to the invention, they can lie closer together so that f_{A,broad}>f_{A}. Because f_{A,broad}>f_{A}, the ICI in such a channel raster is minimised since this provides the opportunity for the neighbouring channels that are not coded together to be spaced further apart from one another.

For the transmission systems with interchannel-time coding and the channel raster represented in FIG. 2(A), broadband filtering is carried out at the multiplexer in order to minimise the ISI. For the channel raster in FIG. 2(A), f_{A}=50 GHz and f_{A,broad}=75 GHz.

The comparative systems without interchannel-time coding have a conventional uniform channel raster as represented in FIG. 2(B). For the channel raster represented in FIG. 2(B), narrowband filtering is carried out at the multiplexer in order to minimise the ICI. The signal therefore experiences strong ISI. In this case Reed-Solomon coding is used for the error correction. The decoding takes place separately for each channel. Both a threshold value decider and a maximum likelihood sequence detector (MLSD) are used as alternative receivers. The channel spacing f_{B} is f_{B}=62 GHZ, in order to obtain the same spectral efficiency as with the channel raster represented in FIG. 2(A).

The net bit rate is 40 Gbits in all the compared systems. Two cases are considered for the conventional comparative systems with Reed-Solomon coding. On the one hand the RS (255,239,8) variant conventionally used in modern systems, in which 239 information symbols that respectively consist of 8 bits are extended by 16 code symbols, so that the RS codeword comprises 255 symbols. On the other hand, a stronger code RS (255,191,8). In this code, the code rate is comparable with that of the interchannel-time coding according to the invention.

In all, the following transmission systems are compared:
A1 interchannel-time coding according to the invention,
A2 interchannel-time coding according to the invention with combined Reed-Solomon coding,
B1 conventional system, uncoded,
B2 conventional system, Reed-Solomon coding RS (255,239,8), and
B3 conventional system, Reed-Solomon coding RS (255,191,8).

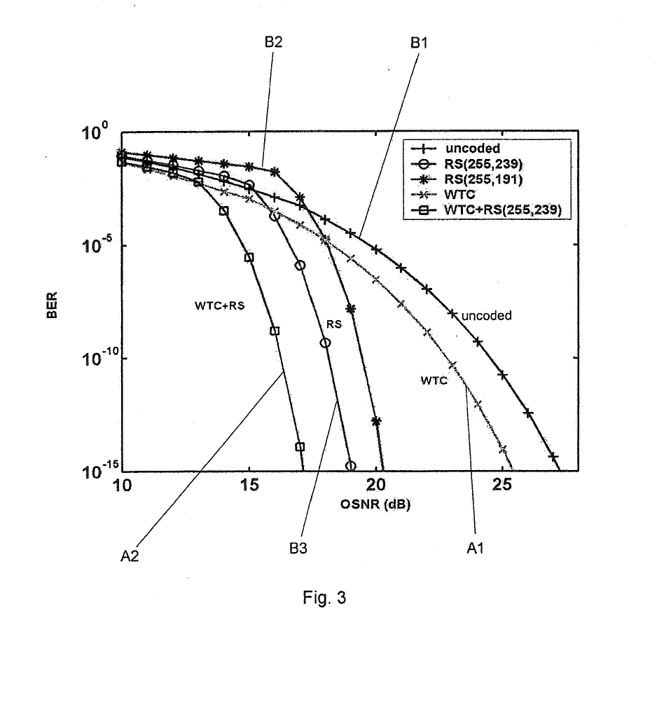

FIG. 3 represents the BER after the decoding on the receiver side for the five compared transmission systems. For a low OSNR, the systems A1, A2 with a coding method according to the invention achieve lower BERs than the comparative systems B1, B2, B3.

Since a Reed-Solomon decoder requires an input BER of about 10⁻² to 10⁻³ in order to be able to correct bit errors, a further improved transmission behaviour can be achieved by combining the interchannel-time coding A1 according to the invention with Reed-Solomon coding to form the transmission system A2. In this case, the interchannel-time coding according to the invention caters for the required low error rate at the input of the Reed-Solomon decoder which can now utilise the high coding gain. Compared with the conventional Reed-Solomon codings RS (255,239,8) (B2) and RS (255,191,8) (B3), the combined transmission system A2 according to the invention achieves a coding gain of about 2 dB over B2 and about 3 dB over B3.

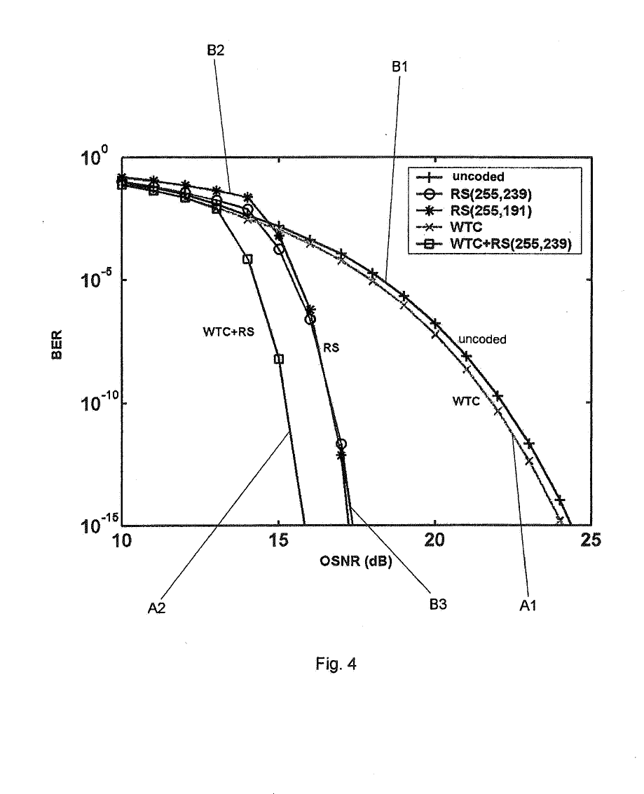

In FIG. 4, the same systems are compared with one another for the case in which the ISI is taken into account for the decoding. In the case of the interchannel-time coding, this can be achieved by using Equation (4); for a conventional transmission system with conventional coding, this can be achieved by using an MLSD. This comparison according to FIG. 4 also shows that the combined system with interchannel-time coding and Reed-Solomon coding works best, with a coding gain of about 2 dB.

For a low OSNR, an optical transmission system with interchannel-time coding according to the invention therefore has a lower BER than comparable conventional transmission systems with conventional coding.

For a high OSNR, a multichannel optical transmission system with interchannel-time coding according to the invention and combined Reed-Solomon coding has a substantially lower BER than comparable conventional transmission systems with conventional coding.

The interchannel-time coding according to the invention, particularly in combination with Reed-Solomon coding, significantly reduces the BER in the receiver. The OSNR necessary in order to achieve a predetermined BER is therefore reduced. It is therefore possible to increase the link length that can be covered by an optical transmission system, so that the system costs are reduced. At the same time, the sensitivity to power-dependent nonlinearities of the fibre link and to noise of the optical amplifiers is reduced.

The interchannel-time coding according to the invention furthermore allows narrower channel spacings and therefore a higher spectral efficiency. The overall costs of an optical transmission system are reduced when using the interchannel-time coding according to the invention, since the transmission filters can be obviated and the decoder can also function as an equaliser. In a conventional system with a conventional Reed-Solomon coding, it is necessary to use an MLSD for this. Since the coding and decoding are carried out blockwise, a plurality of coders and decoders can be used in parallel so that the requirements of the hardware are lowered and therefore the system costs are reduced. This is not possible when using an MLSD.

The interchannel-time coding according to the invention also allows the common detection of a plurality of channels coded together, so that perturbations which affect individual channels have a smaller perturbing effect. With the interchannel-time coding according to the invention, a decoder simultaneously processes for example the signals of two channels (coded pairwise) or three channels (coded in triples). If one of the two channels experiences a strong perturbation but the other does not, for example, then the probability is increased that the decoding will nevertheless function correctly.

The strength of the ICI can furthermore be influenced by the choice of the codeword space. The ICI which occurs can furthermore be employed usefully for the detection process in the coding method according to the invention. In the case of single-channel detection, the ICI would be a perturbing factor. The detection is carried out on the basis of symbols and can therefore be parallelised. By using a plurality of decoders operating in parallel, it is therefore possible to reduce their speed requirements. In the coding method according to the invention, the decoder comprises the functionalities both of an error corrector and of an equaliser. Therefore, only one module is now necessary in order to fulfil both tasks. In addition, transmission filters are no longer required in the multiplexer so that the system costs can be reduced further.

It is particularly important to emphasise that application of the coding method according to the invention is not only limited to multichannel optical transmission systems. It is likewise conceivable to employ the coding method according to the invention in conjunction with digital radio transmission systems, for example for mobile communication, or in conjunction with wireless or cabled computer networks, or for data transmission between satellites, space probes etc. and their ground stations, or in the field of terrestrially laid cable networks for the transmission of telecommunication services etc.

### INDUSTRIAL APPLICATION

The invention is susceptible of industrial application particularly in the field of digital data transmission, as well as the production and operation of networks for digital data transmission.

1. Coding method for multichannel optical transmission systems, in which coding is carried out both in the time direction and over a plurality of channels, wherein
a mapping is selected for the coding such that the simultaneous occurrence of bits with a signal value of ‘1’ in neighbouring channels is excluded.

2. Coding method according to claim 1, wherein
a code design with a maximal Hamming distance is selected.

3. Coding method according to claim 1o, wherein
a code design with minimal Hamming weights is selected.

4. Coding method according to claim 1, wherein
a code design with a minimal number of ‘0 1’ and ‘1 0’ bit patterns in the time direction is selected.

5. Coding method according to claim 1, wherein
all possible codewords are evaluated in the decoding, and the codeword with the maximal metric is selected.

6. Coding method according to claim 1, wherein
the least likely codewords are excluded by means of an algorithm before the actual decoding.

7. Coding method according to claim 1, wherein
the channels are grouped in pairs, the coding being carried out over the channels grouped in pairs.

8. Coding method according to claim 1, wherein
the channels are grouped in triples, the coding being carried out over the channels grouped in triples.

9. Coding method according to claim 1, wherein
the interchannel-time coding is combined with Reed-Solomon coding.

10. Multichannel optical transmission system for carrying out the coding method according to claim 1, comprising
means arranged on the transmitter side for the interchannel-time coding of a plurality of channels which can be transmitted by means of an optical fibre link and means arranged on the receiver side for decoding the channels transmitted via the optical fibre link, the interchannel-time coding means comprising means for carrying out a mapping such that the simultaneous occurrence of bits with a signal value of ‘1’ in neighbouring channels is excluded.

11. Multichannel optical transmission system according to claim 10, wherein
a maximum likelihood symbol-by-symbol decoder is used for the decoding.

12. Multichannel optical transmission system according to claim 10, wherein
a sphere decoder is used for the decoding.

13. Multichannel optical transmission system according to claim 10, comprising
means for additionally carrying out Reed-Solomon coding.

14. Coder comprising means for the interchannel-time coding of transmission sequences of neighbouring channels, wherein
the means for the interchannel-time coding of neighbouring channels comprise means for carrying out a mapping such that the simultaneous occurrence of bits with a signal value of ‘1’ in neighbouring channels is excluded.
